(19) United States
(12) Patent Application Publication
(10) Pub. No.: US 2018/0203602 A1
(43) Pub. Date: Jul. 19, 2018

(54) INFORMATION TERMINAL DEVICE

(71) Applicant: MAXELL, LTD., Kyoto (JP)

(72) Inventors: Nobuo MASUOKA, Oyamazaki (JP); Yasunobu HASHIMOTO, Oyamazaki (JP); Motoyuki SUZUKI, Oyamazaki (JP); Kazuhiko YOSHIZAWA, Oyamazaki (JP); Hiroshi SHIMIZU, Oyamazaki (JP)

(21) Appl. No.: 15/744,045

(22) PCT Filed: Jul. 31, 2015
(86) PCT No.: PCT/JP2015/071857

§ 371 Date: Jan. 11, 2018

(51) Int. Cl. G06F 3/0488; G06F 3/0484; G06F 3/0481

(52) U.S. Cl. CPC G06F 3/04886; G06F 3/04817; G06F 3/04842; G06F 3/04845

(57) ABSTRACT

An information terminal device includes a touch panel which is capable of displaying an image and receiving an operation of a user and includes a display area for displaying the image and an input area dedicated for an operation input, an image processing unit that processes the image to be displayed in the display area, and an operation input unit that detects the operation input to the input area. An area control unit has a function of allocating the input area to a part of the touch panel and performing conversion into an operation on the image displayed in the display area when the operation is performed on the input area.

### TECHNICAL FIELD

The present invention relates to an information terminal device equipped with a touch panel.

### BACKGROUND ART

In recent years, information terminal devices equipped with a touch panel such as smartphones or tablet personal computers (PCs) have become widespread. In the information terminal device equipped with the touch panel, a user touches the panel with a finger and performs a desired input. Therefore, it is required to provide a device configuration in which it is easy to perform a touch operation. For example, it is desirable for the user to be able to perform an operation with one hand.

As a relevant technique, Patent Document 1 discloses a terminal which is intended “to automatically correctly detect areas which are difficult to be touched by the user and areas which are easy to be touched by the user and improve the operability of the user on the basis of the detection” and includes “a touch panel that displays a plurality of input buttons and detects the touched input button, a shake detection unit that detects a shake caused by a touch on the input button, and a display control unit that sets display positions of a plurality of input buttons on the touch panel based on a relation between a position of the touched input button on the touch panel and the shake caused by the touch on the input button.”

### CITATION LIST

### Patent Document

Patent Document 1: JP 2015-11675 A

### SUMMARY OF THE INVENTION

### Problems to be Solved by the Invention

According to the technique disclosed in Patent Document 1, a plurality of input buttons are moved to and displayed on an area (touch area) which is easy to be touched by the user, and thus the user is able to touch with one hand. Since the size of the touch area is limited to each user, for example, if the number of input buttons increases with an increase in a screen size of the touch panel, all the input buttons are unable to be stored in the touch area. At this time, a method of reducing and displaying the input buttons may be used, but it is difficult to distinguish each input button, and an operation mistake is likely to occur. In other words, the technique disclosed in Patent Document 1 is equivalent to a technique of using a touch panel of a size suitable for the size of the hand of the user.

It is an object of the present invention to provide a device configuration in which it is easy for the user to perform an operation, and it is difficult for an operation mistake to occur in an information terminal device equipped with a touch panel.

### Solutions to Problems

The present invention provides an information terminal device including a touch panel which is capable of displaying an image and receiving an operation of a user and includes a display area for displaying the image and an input area dedicated for an operation input, an image processing unit that processes the image to be displayed in the display area, an operation input unit that detects the operation input to the input area, and an area control unit that allocates the input area to a part of the touch panel and performs conversion into an operation on the image displayed in the display area when the operation is performed on the input area.

### Effects of the Invention

According to the present invention, a dedicated input area corresponding to a display screen is set in a part of a touch panel, and thus it is possible to implement an information terminal device in which it is easy for the user to perform an operation, and it is difficult for an operation mistake to occur.

### BRIEF DESCRIPTION OF THE DRAWINGS

FIG. 1 is a block diagram illustrating an internal configuration of an information terminal device (a first embodiment).

FIG. 2A is a diagram illustrating a basic configuration of a touch panel in an input area operation mode.

FIG. 2B is a diagram illustrating a state in which the user is operating an information terminal device.

FIG. 3A is a diagram illustrating an example in which an input area is arranged in a lower left corner of a touch panel.

FIG. 3B is a diagram illustrating an example in which input areas are arranged on both left and right sides of a touch panel.

FIG. 4 is a diagram illustrating an example in which an arrangement of an input area is changed in accordance with a posture of using an information terminal device.

FIG. 5 is a diagram illustrating a change in a display image associated with an input area setting (a second embodiment).

FIG. 6 is a diagram illustrating a change in a display image associated with movement of an input area.

FIG. 7 is a diagram illustrating an example in which an image of a display area is reduced and displayed in an input area (a third embodiment).

FIG. 8 is a diagram illustrating an example in which a reduced image of an image not displayed in a display area is displayed in an input area.

### MODE FOR CARRYING OUT THE INVENTION

Hereinafter, embodiments of the present invention will be described with reference to the accompanying drawings.

### First Embodiment

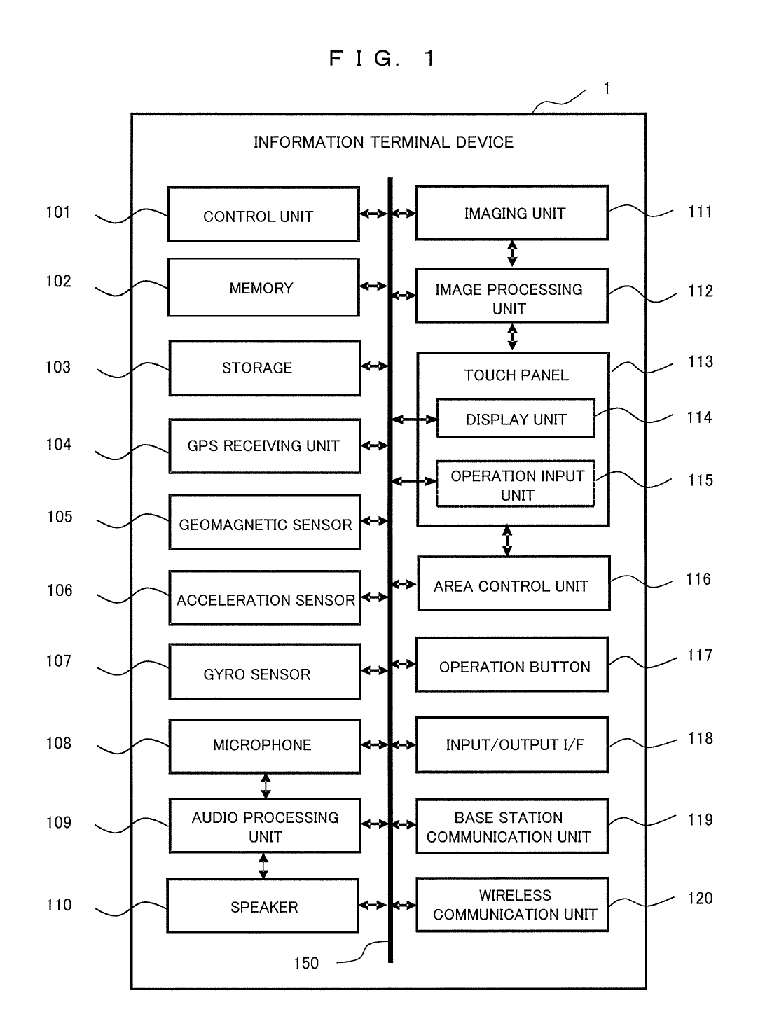

FIG. 1 is a block diagram illustrating an internal configuration of an information terminal device. Here, the description will proceed with an example of a smartphone. An information terminal device 1 is configured by appropriately using a control unit 101, a memory 102, a storage 103, a global positioning system (GPS) receiving unit 104, a geomagnetic sensor 105, an acceleration sensor 106, a gyro sensor 107, a microphone 108, an audio processing unit 109, a speaker 110, an imaging unit 111, an image processing unit 112, a touch panel 113, an area control unit 116, an operation button 117, an input/output I/F 118, a base station communication unit 119, and a wireless communication unit 120, and the respective components are connected to one another via a bus 150.

The control unit 101 is configured with a central processing unit (CPU) or the like, and executes a program stored in the memory 102 to control each component or perform various kinds of processes.

The memory 102 is a flash memory or the like, and stores programs and data used by the control unit 101. Further, the information terminal device 1 includes the storage 103 such as a memory card and is able to store data of music, videos, photographs, and the like.

The GPS receiving unit 104 receives signals from GPS satellites in the sky. Accordingly, a current position of the information terminal device 1 is detected. The geomagnetic sensor 105 detects a direction in which the information terminal device 1 faces. The acceleration sensor 106 detects acceleration of the information terminal device 1, and the gyro sensor 107 detects an angular velocity of the information terminal device 1. With these sensors, it is possible to detect an inclination and motion of information terminal device 1 in detail.

The microphone 108 receives external sounds, and the speaker 110 outputs sounds to the outside. The audio processing unit 109 processes sounds which are input or output.

The imaging unit 111 is a camera or the like, and the image processing unit 112 processes an image input from the imaging unit 111. The image processing unit 112 processes an image to be displayed on a display unit 114 of the touch panel 113.

The touch panel 113 is configured with the display unit 114 and an operation input unit 115. The display unit 114 is a device for displaying images such as a liquid crystal display (LCD), and the operation input unit 115 is disposed on a display surface of the display unit 114. The operation input unit 115 is a touch pad type input device such as a capacitive type, for example, and detects a touch operation performed by a finger or the like as an operation input.

For example, an icon or a menu of an application is displayed on the display unit 114. The operation input unit 115 detects an operation (a tap operation) in which the user pushes a desired icon or menu once with a fingertip. Then, an application corresponding to an icon displayed at a tapped position is executed, or a process corresponding to a menu is executed. Alternatively, when the user performs an operation (a swipe operation) of sliding in a left and right direction while pressing the display surface (the operation input unit 115) with the fingertip in a state in which a home screen is displayed, a process of switching to the home screen is performed.

The area control unit 116 allocates a specific input area in which the user is allowed to input an operation to the touch panel 113. In other words, the display unit 114 is caused to display the input area together with an image. Also, when the operation input unit 115 detects the operation of the user performed in the input area, control is performed such that conversion into an operation to a corresponding image position is performed.

The operation button 117 is a push button switch or the like, and when the operation button 117 is detected to be pushed, the detection is transferred to the control unit 101, and an operation corresponding to the operation button 117 is performed.

The input/output I/F 118 is a universal serial bus (USB) or the like, for example, and is an interface for performing transmission and reception of data with external devices.

The base station communication unit 119 is a communication interface for performing far-field wireless communication with a base station such as wideband code division multiple access (W-CDMA) or long term evolution (LTE). The wireless communication unit 120 is a communication interface for performing wireless communication with an access point for wireless communication via a wireless LAN such as IEEE 802.11a/b/n.

In the present embodiment, when the user operates the touch panel 113, a new operation mode (an input area operation mode) of operating the input area set in the touch panel 113 instead of directly operating an image (icon) displayed on the display unit 114 is introduced. A feature lies in that, when the user operates a certain position in the input area, an operation on a corresponding image (icon) of the display unit 114 is performed. In order to realize this, the area control unit 116 causes a predetermined input area to be displayed in the touch panel 113, and changes a display (arrangement) of an image (icon) as necessary accordingly. Further, when the operation input unit 115 detects the operation of the user performed in the input area, the area control unit 116 performs a conversion operation of regarding it as an operation on a corresponding image (icon) displayed on the display unit 114. Since the input area operation mode is provided, even when the display unit 114 is a large-sized screen, the user is able to operate an input area of a small area with one hand, and the image (icon) is displayed on the display unit 114 without change, and thus it is possible to implement the information terminal device in which it is easy for the user to perform an operation, and it is difficult for an operation mistake to occur.

The tablet personal computer (tablet terminal) also has substantially the same configuration as that of the smartphone illustrated in FIG. 1, and thus description thereof is omitted.

A display example and an operation example of the input area operation mode of the present embodiment will be described below.

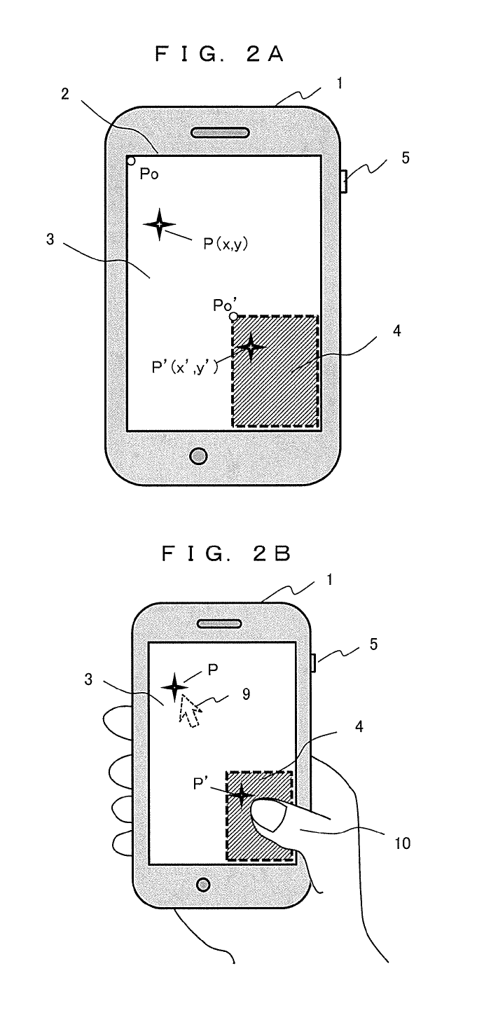

FIG. 2A is a diagram illustrating a basic configuration of the touch panel in the input area operation mode. A touch panel 2 of the information terminal device 1 includes a display area 3 and an input area 4. The touch panel 2 corresponds to a reference numeral 113 of FIG. 1, the display area 3 corresponds to the display unit 114 of FIG. 1, and the input area 4 corresponds to the operation input unit 115 of FIG. 1. In the related art, the display area 3 and the input area 4 are provided at the same position on the touch panel 2 in an overlapping manner, but in the present embodiment, the input area 4 is set as a dedicated area in which the user is allowed to input an operation and set in an area of a part of the touch panel 2, separately from the display area 3. The input area 4 has a substantially similar form obtained by reducing the display area 3 to a fraction of a size and is arranged, for example, at a lower right corner of the touch panel 2. The user is able to operate the entire display area 3 by merely operating the input area 4.

In the present embodiment, since the position of the display area 3 and the position of the input area 4 on the touch panel 2 are different, positions of the display area 3 are associated with positions of the input area 4. In other words, when upper left corner positions Po and Po′ of the respective areas are used as a coordinate origin, coordinates P(x, y) of the display area 3 and coordinates P′(x′, y′) in the input area 4 have a proportional relation indicated by the following formula:

X′=(1/k)x,y′=(1/k)y

“k” is a coefficient greater than 1 and equal to a ratio of the size of the display area 3 and the size of the input area 4. The coordinate conversion is performed by the area control unit 116 of FIG. 1. Accordingly, when the user operates the position P′ in the input area 4, it is converted into an operation on the corresponding position P in the display area 3.

It is desirable to distinguish the input area 4 by displaying a contour line or a color coding (including semitransparent) in order to indicate the area. An operation mode switching button 5 is one of the operation buttons 117 of FIG. 1 and used to turn on or off the input area operation mode, that is, perform switching between a mode in which an operation is performed in the entire display area 3 as in the related art (a normal operation mode) and a mode in which an operation is performed in the dedicated input area 4 (the input area operation mode). The operation mode switching button 5 may be displayed on the display area 3 as an icon.

In a case in which the input area operation mode is set, the normal operation mode is disabled, and even when the position P in the display area 3 other than the input area 4 is operated, no response is performed. As a special case, a dual operation mode in which an operation can be performed in both the input area 4 and the display area 3 may be set, and any one of the input area 4 and the display area 3 may be selected by the switching button 5.

FIG. 2B is a diagram illustrating a state in which the user is operating the information terminal device. In this case, the user selects the input area operation mode and holds the information terminal device 1 with the right hand. When it is desired to perform an operation (for example, a tap) on the P position of the display area 3, it is desirable to perform the operation (tap) on a corresponding P′ position of the input area 4 with a thumb 10 of the right hand. Therefore, it is possible to perform an operation while holding the information terminal device 1 only with the right hand and improve operationality. Particularly, in the case of a tablet terminal having the touch panel 2 with a large screen, in the related art, it is difficult to perform an operation while holding it with one hand, but according to the present embodiment, it is possible to perform an operation without changing the hand and drastically improve usability. Further, since an image (icon) is displayed on the display area 3 with the normal size without change, there is no problem when the user identifies an image.

In the input area operation mode, when there is an operation position deviation (Δx′, Δy′) of the thumb 10 within the input area 4, the operation position deviation (Δx, Δy) for the display area 3 is increased k times. Therefore, when an operation is performed on a fine display image of the display area 3, an operation mistake is likely to occur due to the operation position deviation. As a countermeasure, it is desirable to use a hovering function. In other words, when a finger (operation object) 10 of the user approaches the touch panel surface in the input area 4 within a predetermined distance, the operation input unit 115 detects this, and a cursor 9 (indicated by a broken line arrow) indicating a position to be operated is displayed at a position in the display area 3 corresponding to the approaching position of the finger 10. If the user moves the position of the finger 10 while viewing the position of the cursor 9, it is possible to eliminate the position deviation from a target image (icon) and eliminate the operation mistake.

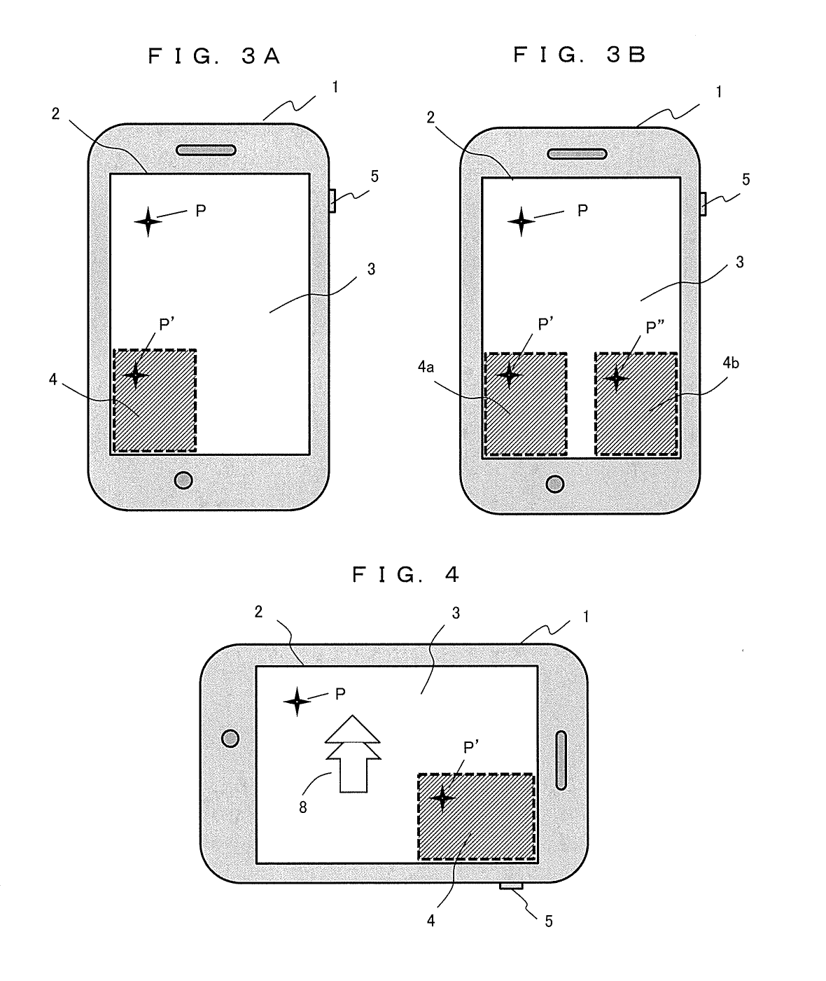

The input area may be arranged at a desired position according to a usage status of the user. FIGS. 3A and 3B illustrate examples in which an arrangement of the input areas is switched.

FIG. 3A is a diagram illustrating an example in which the input area is arranged at the lower left corner of the touch panel. Since the input area 4 is arranged on the left side, it is effective when the user performs an operation with the left hand. In this case, the position P of the display area 3 corresponds to the operation position P′ of the input area 4.

FIG. 3B is a diagram illustrating an example in which the input areas are arranged on both the left and right sides of the touch panel. Since input areas 4a and 4b are arranged on both the left and right sides, the user is able to perform an operation in either the left hand or the right hand. In this case, an operation can be similarly performed on the entire display area 3 regardless of whether the input area 4a or 4b is used. In other words, the position P of the display area 3 corresponds to two operation positions P′ and P″ of the two input areas 4a and 4b. Further, the number of input areas may be three or more.

Further, in a case in which there are the two input areas, it is desirable that cursor marks displayed on the display area 3 by the two input areas be different. It is also possible to assign different operation functions to the two input areas. For example, when a setting is performed such that a cursor is displayed in the left input area 4a, and a click operation is performed in the right input area 4b, it is possible to simply execute a complicated operation.

A switching of the arrangement of the input area 4 and the number of input areas 4 as described above may be selected by the user using the operation mode switching button 5 in accordance with the usage state.

FIG. 4 is a diagram illustrating an example in which the arrangement of the input area is changed in accordance with a posture of using the information terminal device. In FIG. 4, the information terminal device 1 is used in a landscape state (a horizontally long display). The posture (inclination state) of the device is detected by the acceleration sensor 106 of FIG. 1, and the image processing unit 112 rotates an image 8 displayed on the display area 3 in an erecting direction. Accordingly, the area control unit 116 automatically arranges the input area 4 at a predetermined position (for example, the lower right corner) in the touch panel 2. Further, the input area 4 may be arranged at the lowest position (the lower right corner or the lower left corner) in a gravity direction. Accordingly, it is possible to automatically arrange the input area 4 at a position at which it is easy for the user to perform an operation. In a case in which the posture of the device is the horizontal state, since the automatic arrangement according to the inclination state is likely to be unstable, if a default setting is performed such that it is arranged in a predetermined direction with respect to the display direction of a display image 8, an operation is stabilized. In this case, the position P of the display area 3 similarly corresponds to the operation position P′ of the input area 4.

In both cases, the coordinate conversion of the operation position P′ of the input area 4 into the position P of the display area 3 is performed by the area control unit 116. The area control unit 116 may store an arrangement at the time of the previous use with respect to the arrangement of the input area and reproduce the previous arrangement (for example, the lower right corner) when it is used in the input area operation mode.

In the above description, the size of the input area 4 is fixed to a predetermined size, but the user may be able to set it in accordance with the size of the hand (finger) of the user, the size of the touch panel 2, or the like. Further, an aspect ratio of the input area 4 is approximately equal to an aspect ratio of the display area 2 (that is, substantially a similar form), but the aspect ratios may be different. In this case, in the coordinate conversion performed by the area control unit 116, a conversion coefficients k in a vertical direction may be different from a conversion coefficients k in a transverse direction.

According to the first embodiment, even when the display area 3 is a large-sized screen, since the user is able to operate the small input area 4 with one hand, and the image (icon) is displayed on the display area 3 without change, it is possible to implement the information terminal device in which it is easy for the user to perform an operation, and it is difficult for the operation mistake to occur.

### Second Embodiment

In a second embodiment, the display image associated with the setting of the input area is changed.

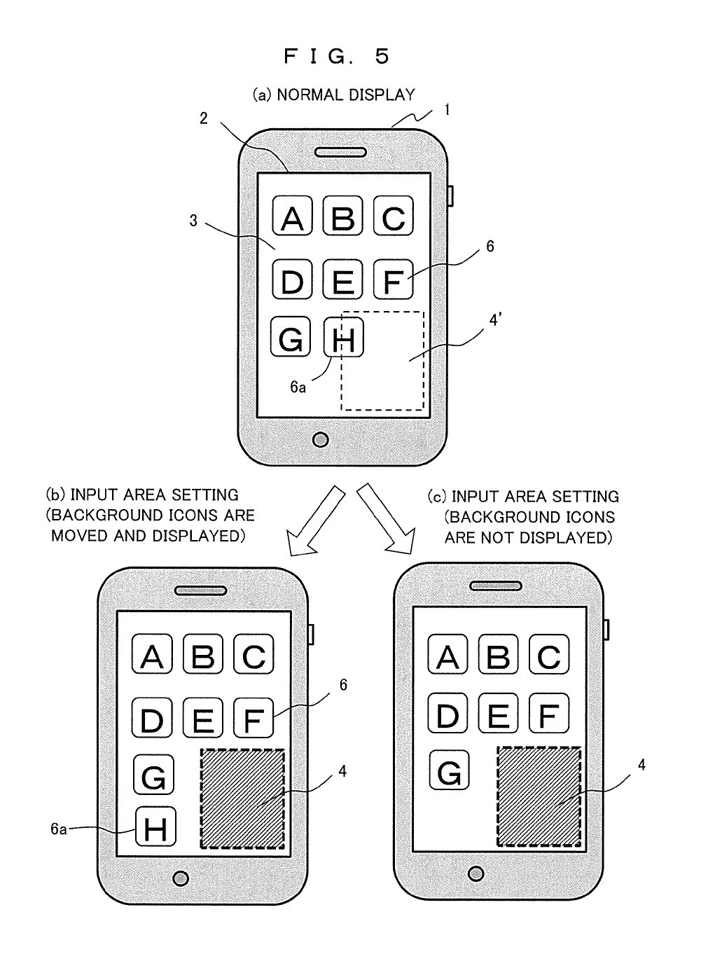

FIG. 5 is a diagram illustrating a change in the display image associated with the setting of the input area. (a) illustrates an example of a normal display (the normal operation mode), and a plurality of icon 6 used in the home screen are displayed on the display area 3. Reference numeral 4′ indicates a predetermined area in which the input area is arranged. The area 4′ predetermined as the input area overlaps a part 6a of an icon (Here, an icon indicated by a symbol “H”). In this case, the image processing unit 112 changes display of the overlapping icon 6a (hereinafter referred to as a “background icon”) as follows.

(b) illustrates an example in which the background icon is moved and displayed. The background icon 6a overlapping the input area 4 is moved to a position not overlapping the input area 4 and displayed. In this example, the icon “H” is moved to a position below the icon “G” and displayed. In this case, it is possible to operate even the background icon 6a smoothly.

(c) illustrates an example in which the background icon is not displayed. If there is no empty space in the display area 3, the background icon 6a overlapping the input area 4 is not displayed. For example, the non-displayed background icon may be moved to a next page and displayed.

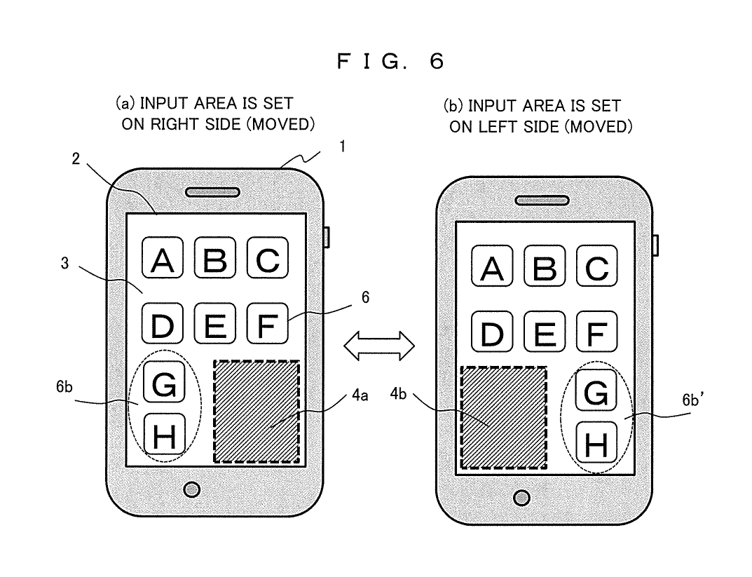

FIG. 6 is a diagram illustrating a change in the display image in accordance with the movement of the input area. (a) illustrates an example in which the input area 4a is set at the position on the right side of the touch panel 2. The display image icon 6 is displayed to avoid the input area 4a. Particularly, icons 6b are displayed on the left side of the input area 4a. In this state, the input area is assumed to be moved to a left side 4b as in (b). In this case, since the icons 6b overlap the input area 4b, the icons 6b are moved to a position 6b′ which is on the right side of the input area 4b.

In this example, the display image is an icon, but, in the case of consecutive images, all the images may be reduced and displayed not to overlap the input area. The change in the display image is executed by the image processing unit 112 in response to an instruction of the area control unit 116. According to the second embodiment, since the display image is changed in conjunction with the setting of the input area, an operation is reliably performed on the image (icon) overlapping the input area.

### Third Embodiment

In a third embodiment, the image of the display area is reduced and displayed in the input area.

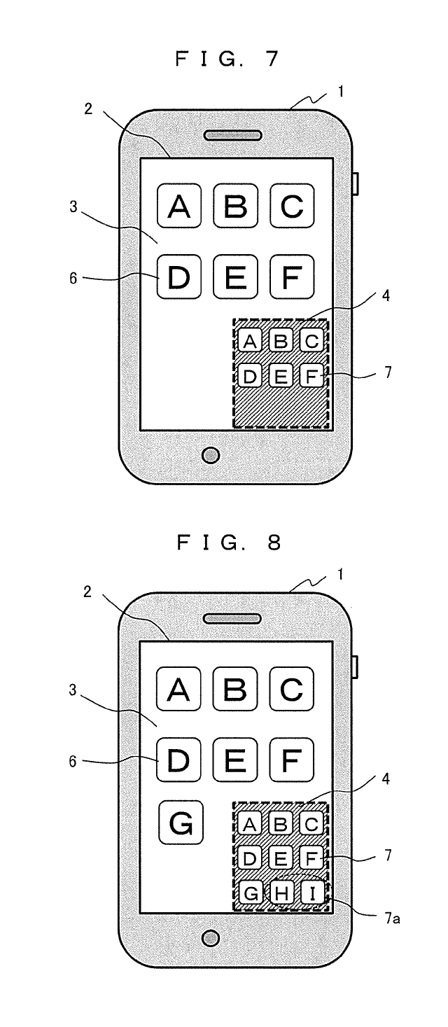

FIG. 7 is a diagram illustrating an example in which the image of the display area is reduced and displayed in the input area. In the input area 4, an image of icons 6 displayed in the display area 3 is reduced, and reduced icons 7 are displayed. An arrangement of the reduced icons 7 in the input area 4 is similar to an arrangement of the icons 6 in the display area 3. In other words, coordinates of the reduced icons 7 and coordinates of the icons 6 are in a corresponding relation. The display of the reduced icons 7 is executed by the image processing unit 112 in response to an instruction of the area control unit 116.

As described above, the image of the display area 3 is reduced and displayed even in the input area 4, and thus the user is able to perform an operation while viewing the reduced image in the input area 4. Therefore, it is possible to reduce a positional deviation from an operation target image in the display area 3 and prevent an operation error.

Here, a plurality of icons 6 (“A” to “F”) displayed in the display area 3 do not overlap with the input area 4, but when a plurality of icons 6 overlap with the input area 4, one of the following processes is performed on the reduced image displayed in the input area 4.

(1) When the background icon is moved and displayed in the display area 3 as in (b) of FIG. 5, the reduced image of the background icon is similarly moved and displayed even in the input area 4.

(2) When the background icon is not displayed in the display area 3 as in (c) of FIG. 5, the reduced image of the background icon is not displayed in input area 4.

(3) Even when the background icon is not displayed in the display area 3 as (c) of FIG. 5, since there is a display space at a corresponding position of the input area 4, the reduced image of the background icon is displayed.

FIG. 8 is a diagram illustrating the process (3), that is, an example in which the reduced images of the images not displayed in the display area 3 are displayed in the input area 4. “H” and “I” which are the background icons are not displayed in the display area 3, but reduced icons 7a are displayed in the input area 4. Accordingly, since it is possible to operate an image (icon) which is not displayed in the display area 3 while viewing the reduced image displayed in the input area 4, the overlapping of the display image and the input area 4 is not a problem.

According to the third embodiment, since the user is able to perform an operation while viewing the reduced image of the input area 4 in addition to the image of the display area 3, there is an effect in that it is possible to reduce the position deviation from the operation target image and prevent the operation error.

The above embodiments have been described to facilitate understanding of the present invention, and the present invention is not limited to a configuration necessarily including all components described above. Further, some of the components of each embodiment can be added, deleted, or replaced with other components of another embodiment. For example, various kinds of arrangements of the input area in the first embodiment and the reduced display in the third embodiment may be arbitrarily combined.

Furthermore, some or all of components, functions, processing units, processing devices, or the like described above may be implemented by hardware, for example, may be designed by an integrated circuit. Further, components, functions, and the like described above may be implemented by software by interpreting and executing a program for implementing the functions through a processor.

Furthermore, in the above-described embodiment, a control line or an information line are illustrated since they are necessary for description, and all control lines or information lines necessary in a product are not necessarily illustrated. Practically, almost all the components may be connected to one another.

### REFERENCE SIGNS LIST

1 information terminal device
2 touch panel
3 display area
4 input area
5 operation mode switching button
6 icon
7 reduced icon
9 cursor
101 control unit
106 acceleration sensor
112 image processing unit
113 touch panel
114 display unit
115 operation input unit
116 area control unit
117 operation button

1. An information terminal device, comprising:
a touch panel which is capable of displaying an image and receiving an operation of a user and includes a display area for displaying the image and an input area dedicated for an operation input;
an image processing unit that processes the image to be displayed in the display area;
an operation input unit that detects the operation input to the input area; and
an area control unit that allocates the input area to a part of the touch panel and performs conversion into an operation on the image displayed in the display area when the operation is performed on the input area.

2. The information terminal device according to claim 1,
wherein the input area has a shape obtained by reducing the display area to a substantially similar form, and
the area control unit has a coordinate conversion function for associating a position in the display area with a position in the input area.

3. The information terminal device according to claim 1,
wherein, when an operation object is brought close to a position within a predetermined distance in order to input the operation on the input area, a cursor indicating a position to be operated is displayed at the position in the display area corresponding to an approaching position of the operation object.

4. The information terminal device according to claim 1, further comprising,
an operation mode switching button that selects an arrangement of the input areas to be set in the touch panel and the number of input areas to be set.

5. The information terminal device according to claim 1, further comprising,
an acceleration sensor that detects a posture of the information terminal device,
wherein the area control unit decides the arrangement of the input area to be set in the touch panel in accordance with the posture of the information terminal device detected by the acceleration sensor.

6. The information terminal device according to claim 1,
wherein the image processing unit moves an image overlapping the input area as the input area is set among images displayed in the display area to a non-overlapping position and displays or does not display the image.

7. The information terminal device according to claim 1,
wherein the image processing unit displays an image displayed in the display area in the input area as a reduced image.

8. The information terminal device according to claim 7,
wherein the image processing unit does not display an image overlapping the input area as the input area is set among images displayed in the display area in the display area, and displays the image in the input area as the reduced image.
